(19) United States
(12) Patent Application Publication
(10) Pub. No.: US 2009/0147997 A1
(43) Pub. Date: Jun. 11, 2009

(54) METHOD AND SYSTEM FOR CORRECTING DISTANCE USING LINEAR REGRESSION AND SMOOTHING IN AMBIENT INTELLIGENCE DISPLAY

(76) Inventors: Dae Hee KIM, Daejeon (KR); Jae Hun CHOI, Sungnam (KR); Myung Eun LIM, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/112,046

(22) Filed: Apr. 30, 2008

(30) Foreign Application Priority Data
Dec. 6, 2007 (KR) 10-2007-0126312

(51) Int. Cl. G06K 9/00

(52) U.S. Cl. 382/106

(57) ABSTRACT

The invention provides a method of correcting a distance between an ambient intelligence display and a user using a linear regression and a smoothing, by which distance information of a user who approaches to the display can be accurately output even in an unanticipated condition using a passive infrared (PIR) sensor and an ultrasonic device.

### CROSS-REFERENCE TO RELATED APPLICATIONS

This application claims the priority of Korean Patent Application No. 2007-0126312 filed on Dec. 6, 2007, in the Korean Intellectual Property Office, the disclosure of which is incorporated herein by reference.

### BACKGROUND OF THE INVENTION

1. Field of the Invention

The present invention relates to a method of correcting a distance between an ambient intelligence display and a user using a linear regression and a smoothing, and more particularly, to a method of correcting a distance using a linear regression and a smoothing in an ambient intelligence display, by which distance information of a user who approaches to the display can be accurately output even in an unanticipated condition using a passive infrared (PIR) sensor and an ultrasonic device.

The present invention is derived from a research project supported by the IT R&D program of MIC/IITA [2006-S007-02, Ubiquitous Health Monitoring Module and System Development].

2. Description of the Related Art

An ambient intelligence system refers to a system for identifying a user who approaches to the system and adaptively presenting images or music in synchronization with a distance from a user. In this system, it is important to accurately recognize the distance from a user in a periodic manner.

However, since users approach to the system in a variety of patterns, and the patterns are not always constant, it may be difficult to recognize a user. In addition, it may be impossible to identify a user or recognize the distance from a user when there is any obstacle in the middle of the path a user approaches or noises are abruptly generated. In other words, various unanticipated conditions maybe generated during identification of a user or recognition of the distance.

Accordingly, the ambient intelligence system for adaptively providing information such as images or music in synchronization with a distance from a user is required to have an ability to accurately identify a user and recognize the distance even in an unanticipated condition.

Therefore, in the field of an ambient intelligence system, there have been needs for a means for accurately identifying a user and recognizing the distance from a user even in an unanticipated condition such as obstacles, noises, or various motions of a user.

### SUMMARY OF THE INVENTION

According to an aspect of the present invention, there is provided a distance correction system of an ambient intelligence display using a linear regression and a smoothing, the distance correction system comprising: a data input unit which inputs current user's distance and angle data and a PIR sensor value received from the ultrasonic receiver and the PIR sensor, respectively; a processing method determination unit which analyzes information input from the data input unit and selects an operation method for correcting the current user's distance and angle values; and an operation unit which corrects and outputs a current user's distance and angle based on the input current distance and angle data and information stored in a queue using the operation method selected by the processing method determination unit.

The operation method may be selected based on whether or not the input current user's distance and angle data are in a normal condition, and the input PIR sensor value.

The processing method determination unit may output the input current user's distance and angle data without change when the input current user's distance and angle data are in a normal condition, and no noise is added.

The processing method determination unit may select a smoothing operation process when the input current user's distance and angle data are in a normal condition, but noise is added. Here, in the smoothing operation process may be performed based on the data stored in the queue and the input data in order to correct the input current user's distance and angle data.

The processing method determination unit may select a regression operation process when the input current user's distance and angle data are in an abnormal condition, and the PIR sensor detects motions of a user. Here, the regression operation process may be performed based on the previous distance and angle data stored in the queue in order to correct the current user's distance and angle data.

The processing method determination unit may determine that there is no user and set the current distance and angle data to 0 when it is determined that the input current user's distance and angle data are in an abnormal condition, and the PIR sensor successively fails to detect a user in n tries (where, n denotes any natural number).

According to another aspect of the present invention, there is provided a method of correcting a display distance, the method comprising: inputting current user's distance and angle data and a passive infrared (PIR) sensor value input from an ultrasonic receiver and a PIR sensor, respectively, mounted on a display; analyzing whether or not the input current user's distance and angle data are in a normal condition and the PIR sensor value; selecting a method of operating the input current user's distance and angle data based on a result of the analysis; and correcting and outputting the current user's distance and angle data based on the selected operation method.

According to the present invention, it is possible to accurately predict a current position of a user based on the previous data stored in a queue even when a user abruptly turns back, when a noise is added to signals, or when ultrasonic waves cannot be accurately transmitted due to obstacles.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating an example for applying a distance correction system of an ambient intelligence display according to the present invention;

FIG. 2 is a block diagram illustrating a configuration of a distance correction system of an ambient intelligence display according to the present invention;

FIG. 3 is a flowchart illustrating a method of correcting a distance in an ambient intelligence display using a linear regression and a smoothing according to the present invention; and

FIG. 4 illustrates a data flow in a queue.

### DETAILED DESCRIPTION OF THE PREFERRED EMBODIMENT

The present invention will now be described in more detail with reference to the accompanying drawings, in which exemplary embodiments of the invention will be shown to be readily understood by those skilled in the art. In the description of the present invention, if it is determined that a detailed description of commonly-used technologies or structures related to the invention may unnecessarily obscure the subject matter of the invention, the detailed description will be omitted.

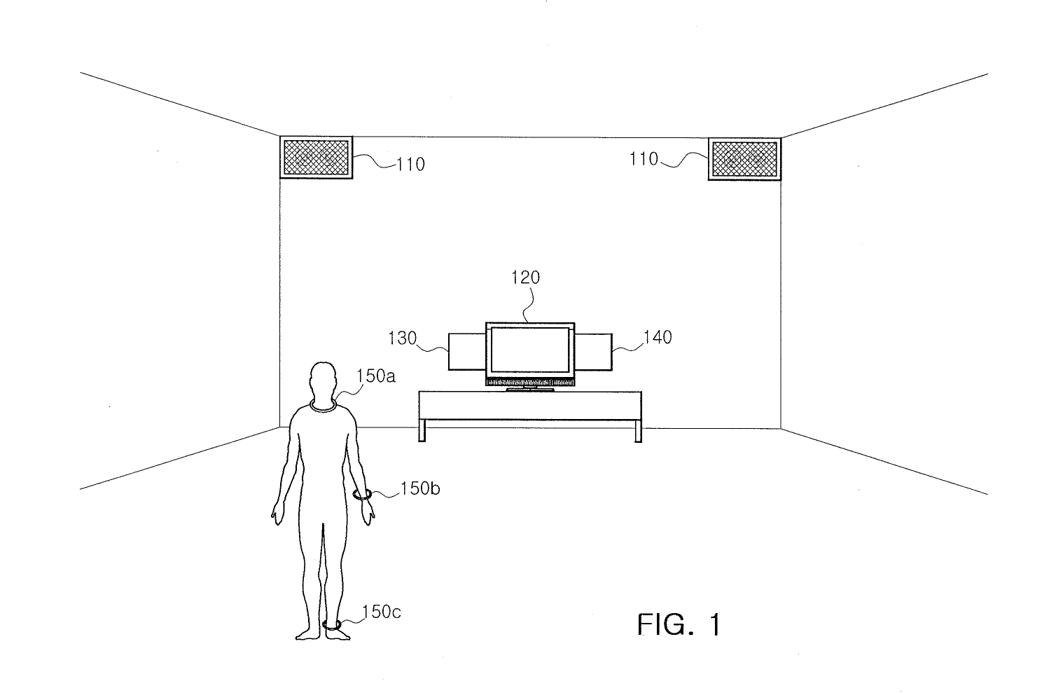

FIG. 1 is a schematic diagram illustrating an example for applying a distance correction system of an ambient intelligence display according to the present invention.

An ambient intelligence system identifies a user who approaches to the display, adaptively outputs images in synchronization with a distance between the user and the display, and provides music.

FIG. 1 illustrates an example of predicting a distance from a user even in an unanticipated condition of an ambient intelligence system using linear regression and smoothing operations.

In FIG. 1, an ambient intelligence display 120 and a loudspeaker are provided in order to provide a user with images and sound. The ambient intelligence display 120 has a passive infrared (PIR) sensor 130 for detecting motions of a user and an ultrasonic receiver 140 for measuring a user distance. Although they are shown to be attached externally, they may be integrated into the display, or may be embodied in various manners.

A user wears ultrasonic transmitters 150a, 150b, and 150c on any part of his/her body to transmit ultrasonic data to an ultrasonic receiver. It is noted that the ultrasonic transmitter may be mounted on a user's neck in the form of a necklace 150a, on a user's wrist in the form of a bracelet 150b, or on any other parts of the body such as an ankle 150c. Such components will be described in more detail later.

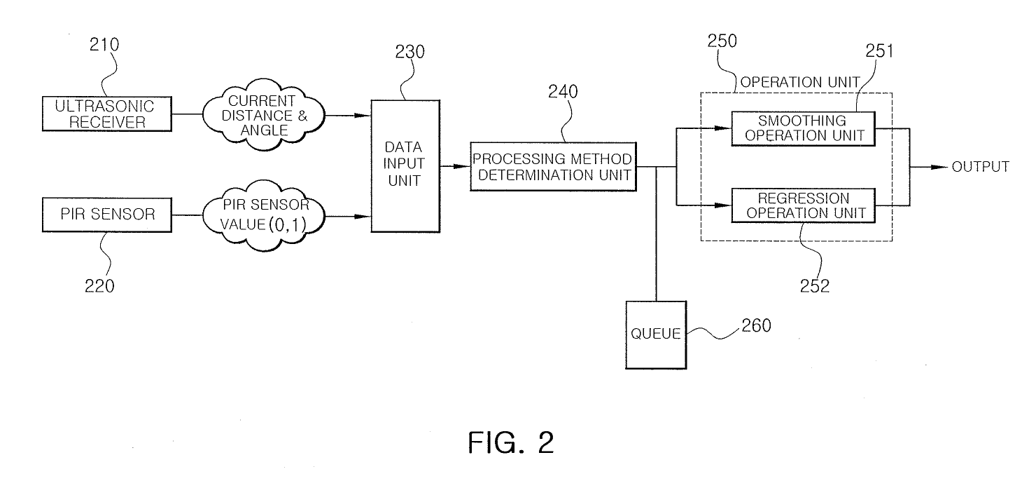

FIG. 2 is a block diagram illustrating a configuration of a distance correction system of an ambient intelligence display according to the present invention.

The distance correction system of the ambient intelligence display comprises: an ultrasonic receiver 210 and a PIR sensor 220 attached to or integrated into a display device; a data input unit 230 which receives current user's distance and angle data and PIR sensor data output from the ultrasonic receiver 210 and the PIR sensor 220 and inputs them; a processing method determination unit 240 which determines a data processing method to output the current user's distance and angle data using information input from the data input unit 230; and an operation unit 250 which outputs current user's distance and angle values using information stored in a queue and information input as described above according to an operation method determined by the processing method determination unit 250. In addition, the operation unit 250 comprises a smoothing operation unit 251 which carries out a smoothing operation process based on a result of determination on the processing method and a regression operation unit 252 which carries out a regression operation process.

In addition, the operation unit 250 further includes a queue for storing previous data to obtain a current user's distance and angle.

Specifically, the ultrasonic receiver 210 receives ultrasonic information from the ultrasonic transmitter mounted on a user side, calculates a distance and an angle between the ultrasonic receiver 210 and the ultrasonic transmitter using a pulse difference of the received ultrasonic information, and delivers them to the data input unit 230. In addition, the PIR sensor 220 detects motions of a user who emanates infrared rays and delivers a PIR sensor value to the data input unit 230. According to the present invention, since the PIR sensor is used to distinguish whether or not the user moves, the PIR sensor value is given “1” when it detect a user, but the PIR sensor value is given “0” when it fails to detect a user, so that the PIR sensor value is delivered to the data input unit 230.

The data input unit 230 delivers the received information, i.e., the current distance and angle, and the PIR sensor value to the processing method determination unit 240.

The processing method determination unit 240 selects a processing method for calculating precise values of the current user's distance and angle using the input information. Specifically, if the input current distance and angle data are in a normal condition, and no noise is added, the input distance and angle data are output as values for current user's distance and angle. On the other hand, if the input current distance and angle data are in a normal condition, and a noise is added, a smoothing operation method is selected. If the smoothing operation method is selected, the smoothing operation unit 250 carries out a smoothing process using the data stored in a queue and the input data to output the current distance and angle data. In addition, if the input current distance and angle data are in an abnormal condition, and the PIR sensor detects a user, the processing method determination unit 240 selects a regression operation method. If the regression operation method is selected, the current user's distance and angle are predicted and output through a regression operation based on the data stored in a queue.

The operation unit uses the data stored in a queue 260 according to the processing method selected by the processing method determination unit 240. The queue stores previous data as much as necessary. In other words, the previous the distance and angle data stored in the queue 260 are used to predict the current user's distance and angle in any unanticipated condition. The size of the queue 260 may be variable. For example, the queue for storing the distance and angle may be set to 4, and the queue for storing the PIR sensor value may be set to 10. It is noted that the present invention is not intended to limit such embodiment to a single example.

As a result, the value output by the operation unit 250 may include any one of the current distance and angle that has been input, the smoothing operation result, or the regression operation result.

Based on the result output from the operation unit 250, the ambient intelligence system outputs images or music in synchronization with the user's distance through a display or a loudspeaker.

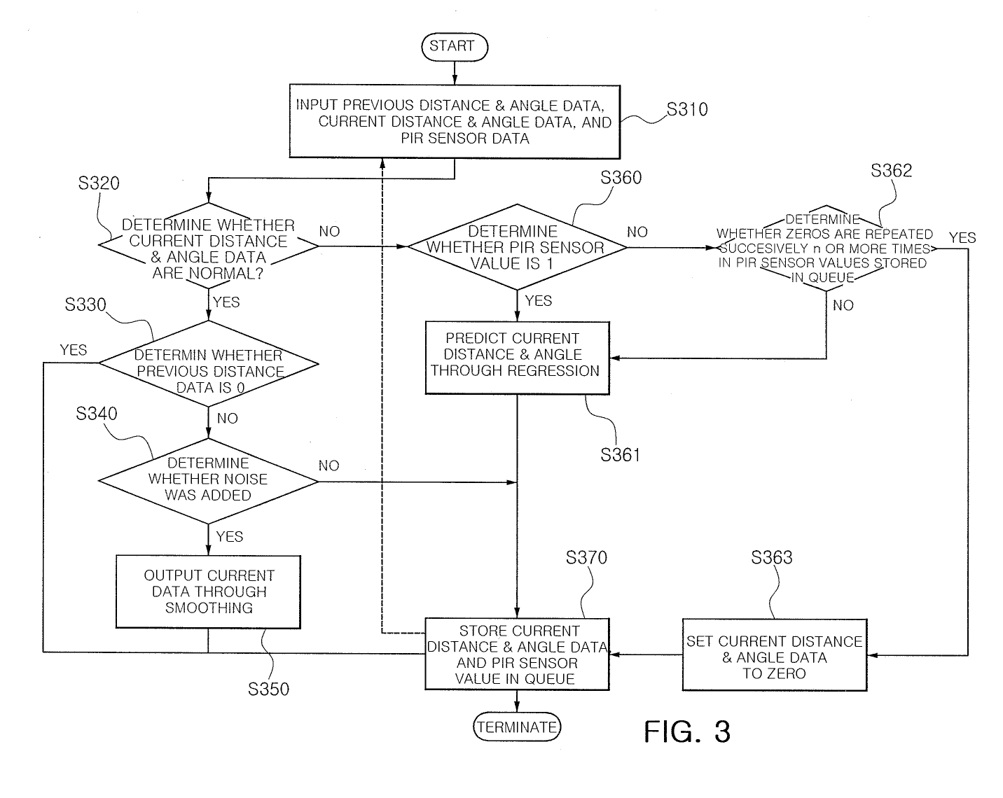

FIG. 3 is a flowchart illustrating a method of correcting a distance in an ambient intelligence display using a linear regression and a smoothing according to the present invention.

A process for measuring and correcting a user's distance value according to the present invention includes: an ultrasonic receiver 210 for receiving ultrasonic data transmitted from ultrasonic transmitters 150a, 150b, and 150c mounted on a user side; and a PIR sensor 220 for detecting a user. This process may be periodically repeated.

Based on the information received by the ultrasonic receiver 210, the current distance data and angle data between the ultrasonic transmitters 150a, 150b, and 150c and the display are calculated and used as input data. The distance data and the angle data are obtained based on a pulse difference of the received ultrasonic data.

Generally, the PIR sensor 220 refers to a sensor for detecting motions of an object emanating infrared rays. Herein, the PIR sensor 220 detects motions of a user, and the detected data from the PIR sensor is also used as input data. The output value of the PIR sensor is given “1” when any motion is detected, whereas it is given “0” when no motion is detected.

Previous distance data and angle data stored in the queue are also used as the input. This allows the correction operation to refer the previous distance and angle data.

As a result, the current distance data and the angle data from the ultrasonic receiver 210, the PIR sensor value concerning motions of a user from the PIR sensor 220, and previous distance and angle data stored in the queue are input through the data input unit 230 (S310). Such data input operation is periodically repeated. The period may be appropriately controlled depending on occasions.

When the aforementioned data are input through the data input unit 230, it is determined whether or not the input current distance and angle data are in a normal condition (S320). An abnormal condition may occur when the distance data has a negative value, a value large than 50 m, or any other unallowable value. The unallowable value may be generated when there is any obstacle between the ultrasonic transmitter mounted on a user side and the ultrasonic receiver mounted on a display side, when a user wearing a transmitter in the form of a bracelet or a necklace stands back, or when noises are added to signal transmission. In addition, other hardware problems may cause such an unallowable value.

If it is determined that the current distance and angle data are in a normal condition, it is determined whether or not the previous distance data is “0”, in order to determine whether or not any noise is generated.

As a result, if it is determined that the previous distance data is “0”, it is determined that it is an initial try. Accordingly, the input current distance and angle data, and the PIR sensor value are stored in the queue 260, and the process is terminated (S370).

Otherwise, if it is determined that the previous distance data is not “0”, it is determined whether or not any noise is added to the input current distance and angle data (S340).

Whether or not noise exists is determined based on the following equation:

Noise Existence=ABS|previous distance data−current distance data|≧Threshold [Equation 1]

where, the threshold value may have, but not limited to, a range between 1 and 2.

As a result, if it is determined that there is no noise, the input current distance and angle data, and the PIR sensor value are stored in the queue 260, and the process is terminated (S370).

On the other hand, if it is determined that there is noise, a smoothing process is carried out for the data stored in the queue and the input data to output the current distance and angle data (S350).

The smoothing process may be performed by calculating the distance and the angle based on two pieces of the most previous data stored in the queue and the current data using the following equation (S350):

Calculated Data=⅓(Queue_Data_end−1+Queue_Data_end+Current Data) [Equation 2]

Then, the calculation result is stored in the queue (S370).

If it is determined that the current distance and angle data are in an abnormal condition, it is determined whether the PIR sensor value detected by the PIR sensor is “1” or “0” (S360).

As a result, if it is determined that the PIR sensor value is “1”, that is, if there is motions of a user, the current user's distance and angle values are predicted using a regression process (S361).

In this case, data sequence pairs (1, QueueData_{end-2}), (2, QueueData_{end-1}) , (3, QueueData_{end}), and (4, QueueData_{end}) may be used. Coefficients a, b, and c of y=ax²+bx+c are obtained from a set of the four sequence pairs based on a least square method. The coefficients may be obtained by modeling \vec{Y}=\vec{AX}, squaring both sides to obtain a matrix A for minimizing \vec{Y}−\vec{AX}=e, and then differentiating with respect to the matrix A. As a result, equation 3 may be obtained as follows:

$$\frac{\partial {e}^{2}}{\partial A} = - 2 E [ \vec{Y} - A \vec{X} ] E [ \overline{{X}^{T}} ] = 0 \\ E [ \vec{Y} \vec{{X}^{T}} ] = AE [ \vec{X} \vec{{X}^{T}} ] \\ A = E [ \vec{Y} \overline{{X}^{T}} ] {( E [ \vec{X} \overline{{X}^{T}} ] )}^{- 1} \qquad [ Equation 3 ]$$

where, A denotes a matrix, and X and Y are vectors.

If equation 3 is applied to four pieces of data, equation 4 may be obtained as follows:

$${A [ \frac{1}{N} {\sum }_{i = 1}^{N} ( \vec{{Y}_{i}} \vec{{X}_{i}^{T}} ) ] [ \frac{1}{N} {\sum }_{i = 1}^{N} ( \vec{{X}_{i}} \vec{{X}_{i}^{T}} ) ]}^{- 1} \qquad [ Equation 4 ]$$

when equation 4 is applied to four pieces of data, it is defined N=4 and

$$\vec{X} = [ \begin{matrix}{x}^{2} \\ x \\ 1\end{matrix} ] .$$

The size of the matrix A is 1×3, and their values denote the coefficients a, b, and c, respectively, of equation y=ax²+bx+c.

A new value of y is predicted by applying a given value of x, (i.e., 4) to equation y=ax²+bx+c. The distance and angle data are predicted in this way, and they are output as the current user's distance and angle data (S361). In addition, the output user's distance and angle data are stored in the queue (S370).

On the other hand, if the current data are abnormal, and zeros are repeated successively n or more times in the PIR sensor value (S362), it is determined that there is nobody in front of the display. Subsequently, both the current user's distance and angle data are set to 0 (S363), and that value is stored in the queue (S370). In this case, the value of n is a variable that can be set and input to the regression operation unit before a user perfectly disappears, and is used to predict the current distance and angle.

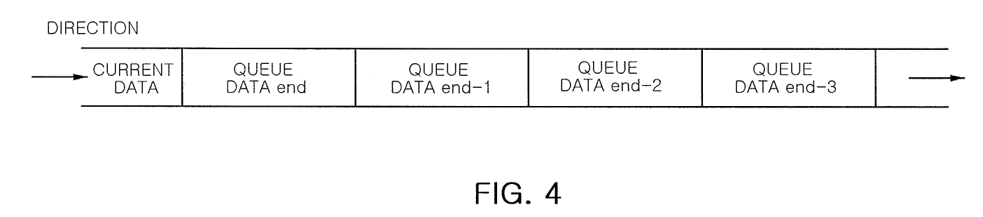

FIG. 4 illustrates a data flow in a queue.

When the current data are input from the data input unit (230), existing data are shifted from left to right, and the rightmost data beyond the size of the queue is discarded.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A distance correction system of an ambient intelligence display, the distance correction system comprising:
a processing method determination unit analyzing current user's distance and angle data input from an ultrasonic receiver and a passive infrared (PIR) sensor, respectively, to select an operation method for correcting the current user's distance and angle data; and
an operation unit correcting and outputting the current user's distance and angle data based on the input current distance and angle data and information stored in the queue using an operation method selected by the processing method determination unit.

2. The distance correction system according to claim 1, wherein the operation method is selected based on whether or not the input current user's distance and angle data are in a normal condition, and the input PIR sensor value.

3. The distance correction system according to claim 2, wherein the processing method determination unit outputs the input current user's distance and angle data without change when the input current user's distance and angle data are in a normal condition, and no noise is added.

4. The distance correction system according to claim 2, wherein the processing method determination unit selects a smoothing operation process when the input current user's distance and angle data are in a normal condition, but noise is added.

5. The distance correction system according to claim 4, wherein the operation unit includes a smoothing operation unit which performs a smoothing operation process based on the data scored in the queue and the input data when the processing method determination unit selects the smoothing operation process in order to correct the input current user's distance and angle data.

6. The distance correction system according to claim 5, wherein, in the smoothing operation process, the current user's distance and angle are calculated based on most previous two pieces of data stored in the queue and current data using the following equation:
Calculated Data=⅓(Queue₋Data₋end−1+Queue₋Data_end+Current Data).

7. The distance correction system according to claim 2, wherein the processing method determination unit selects a regression operation process when the input current user's distance and angle data are in an abnormal condition, and the PIR sensor detects motions of a user.

8. The distance correction system according to claim 7, wherein the operation unit performs a regression operation process based on the previous distance and angle data stored in the queue in order to correct the current user's distance and angle data when the processing method determination unit selects the regression operation process.

9. The distance correction system according to claim 2, wherein the processing method determination unit determines that there is no user and sets the current distance and angle data to 0 when it is determined that the input current user's distance and angle data are in an abnormal condition, and the PIR sensor successively fails to detect a user inn tries (where, n denotes any natural number).

10. A method of correcting a display distance, the method comprising:
inputting current user's distance and angle data and a passive infrared (PIR) sensor value input from an ultrasonic receiver and a PIR sensor, respectively, mounted on a display;
analyzing whether or not the input current user's distance and angle data are in a normal condition and the PIR sensor value;
selecting a method of operating the input current user's distance and angle data based on a result of the analysis; and
correcting and outputting the current user's distance and angle data based on the selected operation method.

11. The method according to claim 10, wherein in the selection of the operation method, the input current user's distance and angle data are output without change when it is determined, as a result of the analysis, that the current user's distance and angle data are in a normal condition, and no noise is included.

12. The method according to claim 10, wherein in the selection of the operation method, a smoothing operation process is selected when it is determined, as a result of the analysis, that the current user's distance and angle data are in a normal condition, and a noise is included.

13. The method according to claim 12, wherein in the smoothing operation process, the input current user's distance and angle data are corrected based on data stored in a queue and the input data.

14. The method according to claim 10, wherein in the selection of the operation method, a regression operation process is selected when it is determined that, as a result of the analysis, the input current user's distance and angle data are in an abnormal condition, and the PIR sensor value detects a user.

15. The method according to claim 14, wherein in the regression operation process, the current user's distance and angle data are corrected based on previous distance and angle data stored in the queue.

16. An ambient intelligence display system comprising:
a display;
an ultrasonic receiver which receives ultrasonic information from a user ultrasonic transmitter mounted on the display and analyzes current user's distance and angle data;
a passive infrared (PIR) sensor mounted on the display to detect whether or not there is a user; and
a correction module which analyzes the current user's distance and angle data and a PIR sensor value received from the ultrasonic receiver and the PIR sensor, respectively, and corrects and outputs the current user's distance and angle values based on previous user's distance and angle information stored in a queue, wherein predetermined images and music are output through the display and a loudspeaker based on the output current user's distance and angle values.

17. The ambient intelligence display system according to claim 16, wherein the correction module comprises:
a data input unit which inputs current user's distance and angle data and a PIR sensor value received from the ultrasonic receiver and the PIR sensor, respectively;
a processing method determination unit which analyzes information input from the data input unit and selects an operation method for correcting the current user's distance and angle values; and
an operation unit which corrects and outputs a current user's distance and angle based on the input current distance and angle data and information stored in a queue using the operation method selected by the processing method determination unit.
